(19) United States
(12) Patent Application Publication
(10) Pub. No.: US 2026/0226871 A1
(43) Pub. Date: Aug. 6, 2026

(54) CASCADE FOR A THRUST REVERSER COMPRISING BLADED STAGES CONNECTED BY THEIR CELLULAR STRUCTURES

(71) Applicant: SAFRAN NACELLES, Gonfreville-L'orcher (FR)

(72) Inventors: Fabrizio PAGANO, Moissy-Cramayel (FR); Michel ROGNANT, Moissy-Cramayel (FR); Julien PIGEON, Moissy-Cramayel (FR); Nicolas MARIE, Moissy-Cramayel (FR)

(73) Assignee: SAFRAN NACELLES, Gonfreville-L'orcher (FR)

(21) Appl. No.: 19/158,305

(22) PCT Filed: Feb. 21, 2024
(86) PCT No.: PCT/FR2024/050231

§ 371 Date: Aug. 20, 2025

(30) Foreign Application Priority Data
Feb. 24, 2023 (FR) FR2301712

(51) Int. Cl. F02K 1/72; B64D 29/00

(52) U.S. Cl. CPC F02K 1/72; B64D 29/00

(57) ABSTRACT

A cascade of vanes for a cascade thrust reverser for an aircraft propulsion assembly nacelle includes: a first bladed stage and a second bladed stage, which are superimposed, each including rows of vanes and of spars which cross over one another so as to form a cellular structure for the passage of the air flow; and front and rear end flanges each rigidly connected to all or some of the spars of at least one of the bladed stages. The cellular structures are connected to each other, independently of the front and rear end flanges, by connectors configured to block relative displacements between the cellular structures.

### TECHNICAL FIELD

The present invention relates to the field of aircraft propulsion assembly nacelles, and more particularly relates to a cascade for a thrust reverser, and a thrust reverser comprising such a cascade.

### PRIOR ART

Thrust reversers are devices for deflecting an air flow, generally a secondary flow, forward through an propulsion assembly, so as to shorten landing distances and limit the load on the brakes on landing gears.

Cascade reversers generally comprise cascades intended to deflect the air flow and integrated into a fixed structure of the reverser intended to be connected to a turbine engine housing. A movable structure of the reverser comprises one or more reverser cowls, and is mounted translatable relative to the fixed structure between an extended position referred to as “direct jet” configuration, and a retracted position referred to as “reverse jet” configuration. In the direct jet configuration, the cascades are arranged in housings defined by the reverser cowls, and they are thus isolated from the secondary flow path of the propulsion assembly by a radially inner wall of the reverser cowls. On the other hand, in the reverse jet configuration, the reverser cowls are axially offset relative to the cascades so that the latter are exposed, on the inside, to the air flow to be deflected, and on the opposite side, to the external environment into which the air flow can thus be redirected.

A thrust reverser cascade generally comprises a front end flange and a rear end flange intended to secure the cascade to a fixed or movable structure of the nacelle. Such a cascade further comprises rows of vanes arranged between the two flanges and shaped to deflect the air flow toward the front of the cascade, and spars connecting the flanges to each other. The rows of vanes cross over with the spars so as to form together a cellular structure defining a multitude of cells forming as many passages for the air flow. In general, the vanes extend orthogonally to the spars. The spars typically extend in a direction within an axial plane whereas the vanes typically extend in a circumferential direction with reference to the axis of the propulsion assembly. Further orientations are nonetheless possible.

The spars absorb most of the mechanical loads of the cellular structure, while the main function of the vanes is to deflect the air flow to perform thrust reversal.

The ability of such a cascade to deflect the air flow effectively therefore depends in particular on the curvature of the vanes. In general, the more pronounced the curvature of the vanes, the higher the aerodynamic performances of the cascade. However, a substantial curvature makes the manufacture of the vanes difficult, or even impossible in some cases. For example, cascades produced by injection molding exist in the prior art; this manufacturing method, which has the advantage of being inexpensive, tends to limit the achievable degree of curvature for the vanes, for reasons of mold releasability.

To remedy these problems, cascades with two bladed stages have been proposed. However, in operation, these cascades pose problems of vibrational instability and aerodynamic disturbances.

### DISCLOSURE OF THE INVENTION

The subject matter of the invention is a cascade providing good aerodynamic performances while being easy and inexpensive to manufacture and stable with respect to vibrations and aerodynamic disturbances in operation.

To this end, it relates to a cascade for a cascade thrust reverser for an aircraft propulsion assembly nacelle, comprising:
at least a first bladed stage and a second bladed stage, which are superimposed, each comprising rows of vanes shaped to deflect an air flow, and spars which cross over with the vanes within each bladed stage so as to form together with the vanes a corresponding cellular structure for the passage of the air flow;
a front end flange and a rear end flange arranged respectively at a front end and a rear end of the cascade and each rigidly connected to all or some of the spars of at least one of the bladed stages;

According to the invention, the respective cellular structures of the bladed stages are connected to each other, independently of the front and rear end flanges, by connecting means configured to block relative displacements between the cellular structures.

The invention makes it possible to increase the performances of the thrust reverser cascades, while providing compatibility with inexpensive manufacturing processes, and by avoiding or limiting, thanks to the connection between cellular structures, problems of vibrational instability and aerodynamic disturbances encountered with two-stage cascades according to the prior art. Such connecting means furthermore make it possible to superimpose bladed stages of different lengths by allowing one or more stages not to be directly connected to each of the front and rear end flanges, which provides many options in terms of reverser cascade optimization.

In some embodiments of the invention, the connecting means comprise first extensions of spars of the first bladed stage and second extensions of spars of the second bladed stage, each of the first extensions being arranged facing a corresponding second extension so that the first and second extensions form mutual stops opposing relative displacements between the cellular structures.

Preferably, the connecting means comprise mutual spar engagement means, formed on the first extensions and the second extensions and cooperating mutually so as to block relative displacements between the cellular structures.

In some embodiments of the invention, the connecting means comprise mutual vane engagement means, formed on vanes of the first bladed stage and on vanes of the second bladed stage and cooperating mutually so as to block relative displacements between the cellular structures.

Preferably, said mutual vane engagement means comprise tongues secured to vanes of one of the bladed stages and extending in the direction of the other bladed stage, and grooves formed in vanes of said other bladed stage and wherein said tongues are received.

In some embodiments of the invention, the connecting means comprise means for securing the respective cellular structures of the bladed stages.

In some embodiments of the invention, the first bladed stage is an inner bladed stage, and the second bladed stage is an outer bladed stage arranged on the inner bladed stage and of which at least one, among a front end and a rear end, is offset from a corresponding front or rear end of the inner bladed stage, in a direction from the front flange to the rear flange.

In some embodiments of the invention, the vanes of the second bladed stage extend in line with corresponding vanes of the first bladed stage.

In other embodiments of the invention, the vanes of the second bladed stage are offset relative to corresponding vanes of the first bladed stage, according to a- or the direction from the front flange to the rear flange.

In some embodiments of the invention, vanes of the first bladed stage comprise respective trailing edges extending beyond respective leading edges of vanes of the second bladed stage, in a direction from the first bladed stage to the second bladed stage.

In some embodiments of the invention, a spacing between consecutive rows of vanes of the first bladed stage is different from a spacing between consecutive rows of vanes of the second bladed stage.

The invention also relates to a cascade thrust reverser for an aircraft propulsion assembly nacelle, comprising at least one cascade of the type described above.

### BRIEF DESCRIPTION OF THE DRAWINGS

The invention will be better understood, and further details, advantages and features thereof will become apparent on reading the following description given by way of non-limiting example and with reference to the appended drawings wherein:

FIG. 1 is a schematic perspective view of an aircraft propulsion assembly comprising a cascade thrust reverser according to the prior art, shown in a direct jet configuration;

FIG. 2 is a similar view to FIG. 1, showing the thrust reverser in a reverse jet configuration;

FIG. 3 is a schematic axial sectional view of the thrust reverser of the propulsion assembly of FIG. 1, shown in a direct jet configuration;

FIG. 4 is a similar view to FIG. 3, showing the thrust reverser in a reverse jet configuration;

FIG. 5 is a schematic view of a vane of a cascade of the thrust reverser of the propulsion assembly of FIG. 1;

FIG. 6 is a schematic perspective view of a cascade for a thrust reverser according to a preferred embodiment of the invention;

FIG. 7 is a schematic sectional view of a cascade for a thrust reverser according to a preferred embodiment of the invention;

FIG. 8 is a schematic sectional view of a cascade for a thrust reverser according to another preferred embodiment of the invention;

FIG. 9 is a schematic axial sectional view of a cascade for a thrust reverser according to another preferred embodiment of the invention;

FIG. 10 is a schematic axial sectional view of a cascade for a thrust reverser according to another preferred embodiment of the invention;

FIG. 11A is a schematic axial sectional view of a pair of vanes respectively intended to be part of two superimposed vane stages of a thrust reverser cascade according to a preferred embodiment of the invention, shown disassembled;

FIG. 11B is a similar view to FIG. 11A, showing the assembled pair of vanes;

FIG. 11C is a similar view to FIG. 11B, showing a pair of vanes respectively intended to be part of two superimposed bladed stages of a thrust reverser cascade according to another preferred embodiment of the invention;

FIG. 12 is a similar view to FIG. 9, showing a cascade for a thrust reverser wherein the vanes define pairs of vanes similar to that of FIG. 11C;

FIG. 13 is a similar view to FIG. 12, showing a cascade for a thrust reverser according to another preferred embodiment of the invention;

FIG. 14A is a very schematic axial sectional view of a cascade for a thrust reverser according to a preferred embodiment of the invention;

FIG. 14B is a very schematic top view, i.e. radially external, of the cascade for a thrust reverser of FIG. 14A;

FIG. 15 is a schematic perspective view of a pair of vanes respectively intended to be part of two superimposed bladed stages of a thrust reverser cascade according to another preferred embodiment of the invention;

FIG. 16A is a schematic axial sectional view of a thrust reverser for a propulsion assembly, comprising a cascade according to a preferred embodiment of the invention;

FIG. 16B is a schematic axial sectional view of a thrust reverser for a propulsion assembly, comprising a cascade according to another preferred embodiment of the invention;

FIG. 17 is a schematic perspective view of a cascade for a thrust reverser according to another preferred embodiment of the invention.

In all of these figures, identical references may designate identical or similar elements.

### DETAILED DISCLOSURE OF PREFERRED EMBODIMENTS

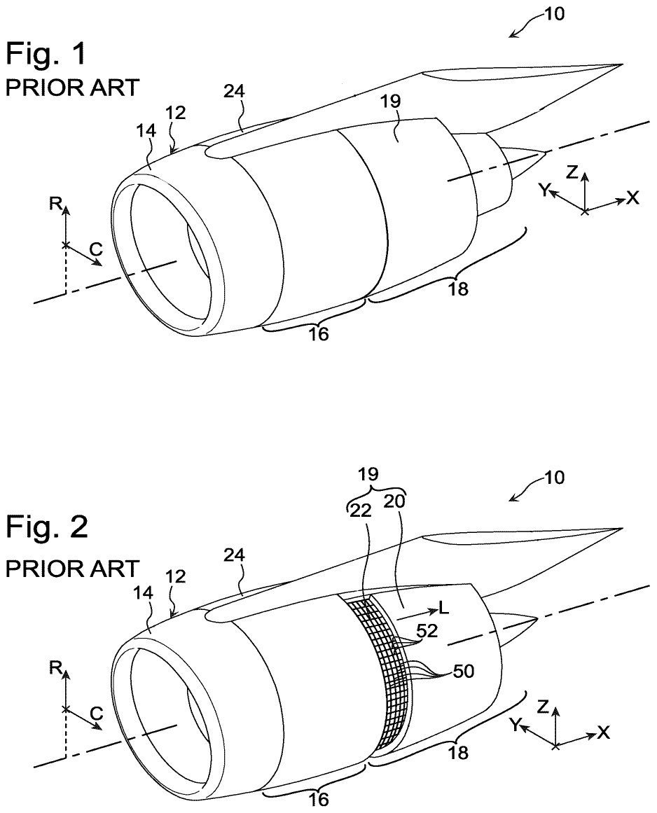

FIGS. 1 and 2 illustrate a propulsion assembly 10, generally comprising a turbojet engine (hidden in the figures) for example of the turbofan type, surrounded by a nacelle 12. This nacelle comprises, in a manner known per se, an air inlet 14, a middle section 16, and also a rear section 18 integrating a cascade type thrust reverser 19. FIG. 1 shows the nacelle 12 in a direct jet configuration, i.e. with the thrust reverser in a retracted configuration, whereas FIG. 2 shows the nacelle in a reverse jet or thrust reversal configuration, i.e. with the thrust reverser in a deployed configuration. Thus, it can be seen in FIG. 2 that a cowl 20 of the rear section 18 is in the retracted position, and shows a set of cascades 22 of the thrust reverser, distributed about an axis A of the nacelle and more generally of the propulsion assembly.

Throughout this description, the axial direction X is the direction of the axis A, the vertical direction Z is a direction orthogonal to the axial direction X and provided to be oriented along the vertical when the propulsion assembly 10 equips an aircraft parked on the ground, and the transverse direction Y is orthogonal to the previous two directions. Furthermore, the radial direction R and the circumferential direction C or azimuth direction are defined with reference to the axis A, the radial direction R being at all points the direction orthogonal to the axis A and passing through the latter, and the circumferential direction C being at all points orthogonal to the radial direction R and to the axis A. Finally, the “upstream” and “forward” directions on one hand, and “downstream” and “rearward” on the other, are defined along the direction of the axis A, with reference to the general direction of gas flow in the turbojet engine, from upstream or forward to downstream or rearward.

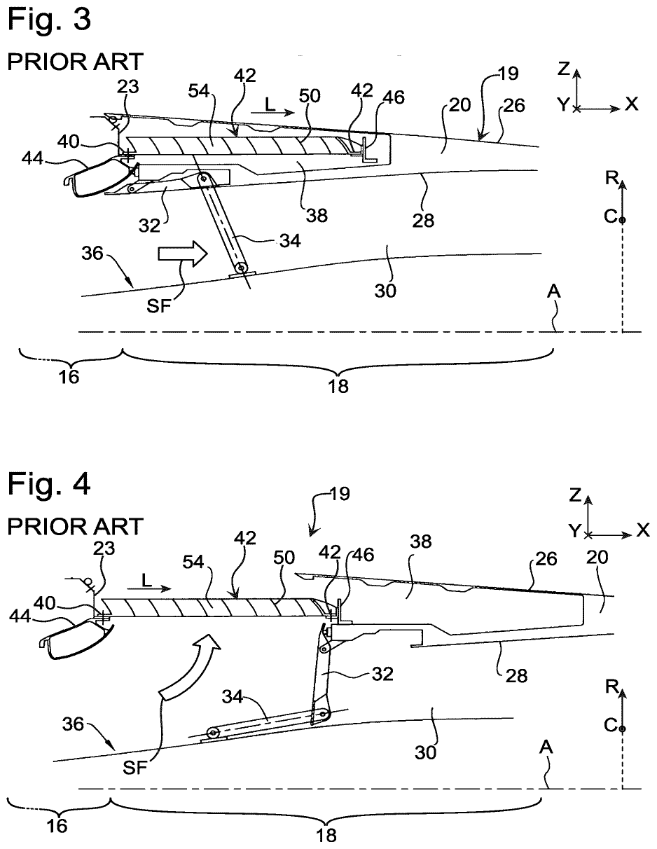

FIGS. 3 and 4 illustrate such a thrust reverser 19 in more detail, respectively in a direct jet configuration and in a reverse jet configuration.

The thrust reverser 19 is typically disposed downstream of a fan casing 23 of the turbojet engine, and of the associated fan cowl 24 (FIGS. 1 and 2) which is part of the middle section 16 of the nacelle. The reverser 19 comprises at least one cowl, such as the cowl 20, axially movable between a forward or retracted position, corresponding to the direct jet configuration, and a rearward or deployed position, corresponding to the reverse jet configuration. Such a cowl 20 has an outer wall 26 and an inner wall 28 which are respectively intended, in the direct jet configuration (FIG. 3), to be inscribed in the aerodynamic outer shell of the nacelle and to externally delimit an annular channel 30 wherein a secondary flow SF of the turbojet engine flows. The reverser 19 comprises at least one reversing flap 32 hingedly mounted on the inner wall 28 of the cowl 20 and actuated by at least one connecting rod 34 when the cowl 20 moves rearward such that, in the reverse jet configuration (FIG. 4), at least a part of each reversing flap 32 extends in the annular channel 30 so as to deflect at least a part of the secondary flow SF from the annular channel 30 toward the cascade 22. The connecting rod 34 is for example articulated on a fixed inner structure 36 of the nacelle, which internally delimits the annular channel 30.

Each movable cowl 20 comprises at least one housing 38 delimited between its outer 26 and inner 28 walls and making it possible to house one or more of the cascades 22, in the direct jet configuration (FIG. 3).

One of the cascades 22 can be seen in FIGS. 3 and 4, and is illustrated here in a known configuration. Each of these cascades 22 has a general perforated plate shape curved in the circumferential direction C.

Each cascade 22 comprises in particular a front end flange 40 and a rear end flange 42 respectively attached to a front frame 44 and a rear frame 46 which are each secured to a fixed structure of the nacelle such as the fan housing 23.

Furthermore, each cascade comprises rows of vanes 50 (FIGS. 2-4) arranged between the two flanges 40, 42 and shaped to deflect the air flow forward, and spars 52 (FIG. 2) each rigidly connecting the front end flange 40 to the rear end flange 42 (FIGS. 3-4). The rows of vanes 50 cross over with the spars 52 so that these vanes 50 and spars 52 form together a cellular structure 53 defining a multitude of grooves 54 each forming a passage for the air flow. The spars 52 extend in a direction from the front flange 40 to the rear flange 42, this direction being typically a direction parallel to the axis A or, more generally, a longitudinal direction L within a plane containing the axis A of the nacelle. The rows of vanes 50 preferably extend along a lateral direction orthogonal to the aforementioned direction, such as the circumferential direction C.

Thus, when switching from the direct jet configuration (FIG. 3) to the reverse jet configuration (FIG. 4), each cowl 20 moves rearward and uncovers both the inside and the outside of the cascades 22, thereby exposing the latter to the secondary flow SF on the inside and to the external environment on the outside. In the example illustrated, the displacement of each cowl 20 furthermore causes the deployment of the reversing flaps 32 in the annular channel 30 of the secondary flow. This air flow is thus deflected by the flaps 32 toward the cascades 22 and flows through the cells 54 while being deflected forward by the vanes 50 of the cascades 22 so as to generate a reverse thrust.

The sliding of each cowl 20 between its forward and rearward positions is generally carried out by cylinders (not illustrated) distributed about the axis A of the nacelle and for example attached at the front to a fixed part of the nacelle, such as the front frame 44, and at the rear to the cowl 20, by means of suitable fittings.

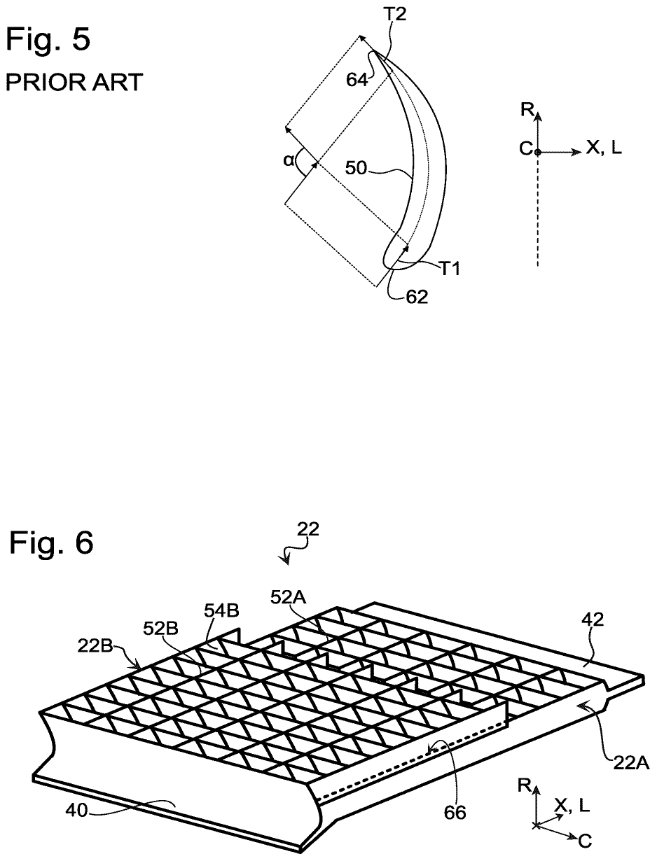

With reference to FIG. 5, a vane 50 of a cascade according to the prior art, such as the cascade 22 seen in FIGS. 3 and 4, has an angle of curvature a, defined as the angle between the tangents T1 and T2 to the camber line 60 of the vane, respectively defined at the leading edge 62 and at the trailing edge 64 of the vane. This angle of curvature α reflects the more or less pronounced degree of curvature of the vane, on which the aerodynamic performances of the cascade 22 is dependent. The manufacturing processes commonly used for vanes impose a minimum value on the angle a and therefore limit the achievable degree of curvature of the vanes.

As explained above, in order to increase the aerodynamic performances of a thrust reverser cascade while allowing easy and inexpensive manufacture thereof, the invention provides a cascade 22 with several superimposed bladed stages 22A, 22B, as illustrated in FIG. 6.

Like the cascade according to the prior art described above, the present cascade 22 comprises a front end flange 40 and a rear end flange 42, and each bladed stage 22A, 22B comprises rows of vanes 50A, 50B shaped to deflect the air flow, for example toward the front side of the cascade, and the spars 52A, 52B, for example in the form of rectilinear beams of rectangular cross-section. The rows of vanes 50A, 50B cross over with the spars 52A, 52B within each bladed stage 22A, 22B so as to form together with the spars 52A, 52B a corresponding cellular structure 53A, 53B defining a multitude of cells 54A, 54B each forming a passage for the air flow through the cascade 22.

The front end flange 40 and the rear end flange 42 are arranged respectively at a front end and a rear end of the cascade 22 and are each rigidly connected to the spars 52A, 52B, or at least to some of the spars 52A, 52B, of at least one of the bladed stages. In the example illustrated in FIG. 6, the spars 52A of the inner bladed stage 22A rigidly connect the front end flange 40 to the rear end flange 42.

In order to provide the cascade with the required stability with respect to vibrations and aerodynamic disturbances in operation, the invention furthermore provides that the respective cellular structures 53A, 53B of the bladed stages 22A, 22B are connected to each other, independently of the flanges 40 and 42, by connecting means 66 configured to block relative displacements between the cellular structures 53A, 53B. By “independently of the flanges”, it should be understood that the connecting means 66 act directly on the spars and/or on the vanes of the bladed stages 22A, 22B. In other words, the load paths within the connecting means 66 do not pass through the flanges 40 and 42. The connecting means 66 are preferably configured to rigidly connect the cellular structures 53A, 53B independently of the flanges 40 and 42, as will become more apparent hereinafter.

The connecting means 66 can be configured to act in the whole region facing the cellular structures 53A, 53B, i.e. along the entirety of each row of vanes 50A, 50B and each spar 52A, 52B, or only in one or more zones of this facing region, i.e. along one or more segments of one or more spars or only along certain spars and/or along one or more segments of one or more rows of vanes or only along certain rows of vanes, as will become more apparent hereinafter.

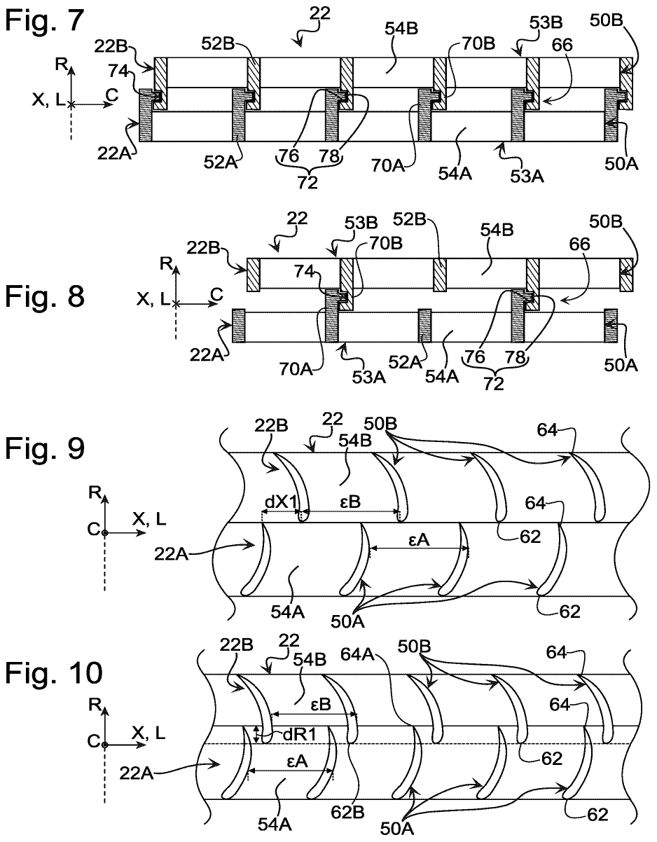

With reference to FIG. 7, the spars 52A of the first bladed stage 22A have first extensions 70A, whereas the spars 52B of the second bladed stage 22B have second extensions 70B. The first extensions 70A and the second extensions 70B form—or, in the example illustrated, are part of—the aforementioned connecting means 66. More specifically, the first extensions 70A and the second extensions 70B are arranged facing one another so as to form mutual stops opposing relative displacements between the cellular structures 53A, 53B, for example along the circumferential direction C, or more generally along a direction orthogonal to the longitudinal direction L of the spars 52A, 52B. For this purpose, the first extensions 70A extend in the direction of the second bladed stage 22B, whereas the second extensions 70B extend in the direction of the first bladed stage 22A. The first extensions 70A and the second extensions 70B thus extend, for example, along the radial direction R.

Of course, in embodiments wherein the extensions 70A, 70B are in the form of simple stops, the latter only act with respect to the relative displacements between the cellular structures 53A, 53B in a given direction. For example, still with reference to FIG. 7, the blocked displacements are the displacements of the lower cellular structure 53A oriented in the counterclockwise direction viewed from the rear, i.e. in the direction opposite to that of the arrow indicating the circumferential direction C, as well as the displacements of the upper cellular structure 53B oriented in the clockwise direction viewed from the rear, i.e. in the direction of the arrow indicating the circumferential direction C.

In order to block at least one additional degree of freedom, the first extensions 70A and the second extensions 70B advantageously comprises mutual engagement means, referred to hereinafter as mutual spar engagement means 72, which are designed to oppose relative displacements of the cellular structures 53A, 53B, preferably in one or more direction(s) different from the direction wherein the extensions 70A, 70B act. Thus, in the example illustrated, the mutual spar engagement means 72 are designed to oppose relative displacements of the cellular structures 53A, 53B along the radial direction R.

These mutual spar engagement means 72 define, for example, sliding connections, of axes 74 parallel to the longitudinal direction L of the spars. For this purpose, the mutual spar engagement means 72 comprise, for example, longitudinal grooves 76 formed in the second extensions 70B, and longitudinal tongues 78 formed protruding from the first extensions 70A, for example in the circumferential direction C, and received—preferably embedded—in the grooves 76.

In such cases, the extensions 70A and 70B advantageously have a flexibility allowing the mutual engagement of the grooves 76 and tongues 78 by elastic snap fastening. Alternatively, in some embodiments, the stages 22A and 22B are assembled by sliding the tongues 78 within the grooves 76 along the latter.

In the example illustrated in FIG. 7, all the spars 52A and 52B comprise respective extensions 70A, 70B provided with mutual spar engagement means 72.

In other embodiments such as that illustrated in FIG. 8, only some of the spars 52A and some of the spars 52B comprise respective extensions 70A, 70B.

Furthermore, the extensions 70A, 70B can extend over the entire length of the spars 52A, 52B in question or only along a part of this length. Thus, according to needs, it can be provided that the extensions 70A, 70B only extend along one or more segments of each spar 52A, 52B or some of the spars 52A, 52B, excluding one or more other segments of said spars.

With reference to FIGS. 9 and 10, it should be understood that different relative arrangements of the respective vanes 50A, 50B of the cellular structures 53A, 53B are furthermore possible within the scope of the present invention.

Thus, in the example of FIG. 9, the rows of vanes 50A are offset by a distance dR1 relative to the rows of vanes 50B along the direction from the front flange 40 to the rear flange 42, i.e., the longitudinal direction L of the spars, corresponding in the example illustrated to the axial direction X. Furthermore, in this example, the rows of vanes 50A are entirely radially offset relative to the rows of vanes 50B. In other words, the rows of vanes 50A have no radial overlap relative to the rows of vanes 50B.

In the example of FIG. 10, the rows of vanes 50A are slightly axially offset from the rows of vanes 50B and furthermore have a radial overlap dR1 relative to the latter. It should thus be understood that vanes 50A of the first bladed stage 22A comprise respective trailing edges 64A extending beyond respective leading edges 62B of vanes 50B of the second bladed stage 22B, in a direction from the first bladed stage 22A to the second bladed stage 22B.

In both cases, each vane 50A of one of the bladed stages 22A forms with a corresponding vane 50B, i.e. the closest one, of the other bladed stage 22B, a pair of vanes providing comparable air flow redirection performances to those that a single vane having substantially the same angle of curvature would have. Such a pair of vanes has the advantage of being simpler and more economical to manufacture than a single vane with the same properties.

Such offsets between rows of vanes of the different bladed stages can increase the aerodynamic performances of the cascade due to a favorable redistribution of the speed and pressure profiles in the different stages.

The spacing EA between consecutive rows of vanes within one of the bladed stages 22A can furthermore be identical to or different from the spacing EB between consecutive rows of vane within the other—or another—of the bladed stages 22B.

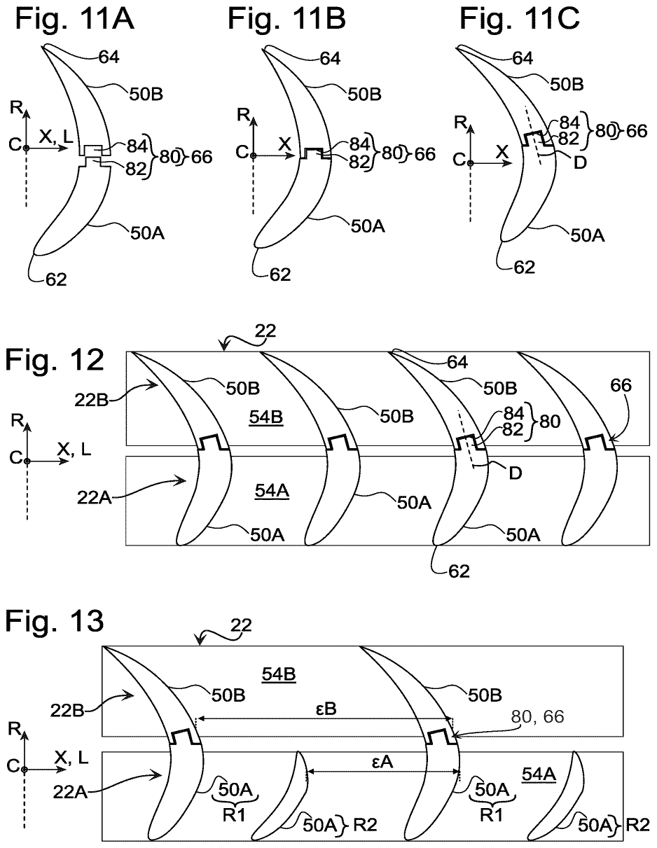

In another example that will now be described with reference to FIGS. 11A-11B, the rows of vanes 50B can extend in line with the rows of vanes 50A.

In such a case, the connecting means 66 can advantageously comprise mutual vane engagement means 80, formed on vanes 50A of the first bladed stage 22A and on vanes 50B of the second bladed stage 22B, and cooperating mutually so as to block relative displacements of these vanes. These means are shown in a non-engaged state in FIG. 11A, for illustrative purposes, and in an engaged state in FIG. 11B.

These mutual vane engagement means 80 comprise, for example, tongues 82 secured to vanes 50A of one of the bladed stages 22A and extending in the direction of the other bladed stage 22B, and grooves 84 formed in vanes 50B of the other bladed stage 22B and wherein the tongues 82 are received—preferably embedded.

The tongues 82 of the vanes 50A therefore extend in the direction of the vanes 50B of the other stage. These tongues 82 are for example oriented along the radial direction R—this is the case illustrated in FIGS. 11A-11B—or at least along a direction having a radial component, for example a direction D inclined radially outward in the upstream direction, as in the example illustrated in FIG. 11C.

Thus, the vanes 50A, 50B provided with such means are prevented from moving relative to one another in the longitudinal direction L of the spars, corresponding in this case to the axial direction X.

The vanes 50A, 50B are shaped so that the pair formed of a vane 50A and a vane 50B, assembled or joined to one another by corresponding mutual vane engagement means 80, substantially defines an aerodynamic profile shape, i.e. a shape equivalent to that of a conventional vane, as shown in FIGS. 11A-11C.

In other embodiments, the mutual vane engagement means 80 can be configured to block displacements in the circumferential direction C or in the two directions Land C, or even in the radial direction R or more generally the direction from the first bladed stage 22A to the second bladed stage 22B.

Furthermore, FIG. 12 illustrates an example wherein all the rows of vanes 50A, 50B are provided with the mutual vane engagement means 80, whereas FIG. 13 illustrates an example wherein only some of the rows of vanes 50A, 50B are provided with the mutual vane engagement means 80.

More particularly, FIG. 13 shows an example wherein one of the stages 22B has rows of vanes 50B facing some of the rows R1 of vanes 50A of the other stage 22A but not facing some other rows R2 of vanes 50A of the stage 22A. The spacing εA between consecutive rows of vanes within the inner stage 22A is thus less than the spacing EB between consecutive rows of vanes within the outer bladed stage 22B. The aerodynamic profiles defined by the pairs of vanes formed by the vanes 50A and the vanes 50B of the rows R1 can have a more pronounced curvature and/or a greater height than the curvature and/or the height of the vanes 50B of the rows R2, which can contribute to the aerodynamic performances of the cascade. The relatively substantial spacing EB between the aforementioned pairs of vanes can furthermore help facilitate the manufacture of the cascade, particularly facilitate mold release in the case of manufacture by molding.

Another configuration, wherein the configurations of the inner stages 22A and outer stages 22B would be inverted relative to those of FIG. 13, would offer the same advantages in terms of cascade manufacture, while making it possible to increase the air flow through the cascade due to a reduction in the number of leading edges in the entry plane of the cascade, resulting in a reduction in the obstruction perceived by the air flow.

Similarly to what is explained above with regard to the extensions 70A, 70B, the mutual vane engagement means 80 can be defined over the entire length of the rows of vanes 50A, 50B in question or only along a part of this length. Thus, according to needs, it can be provided that these means extend only along one or more segments of each row of vanes or some of the rows of vanes, excluding one or more other segments of said rows of vanes.

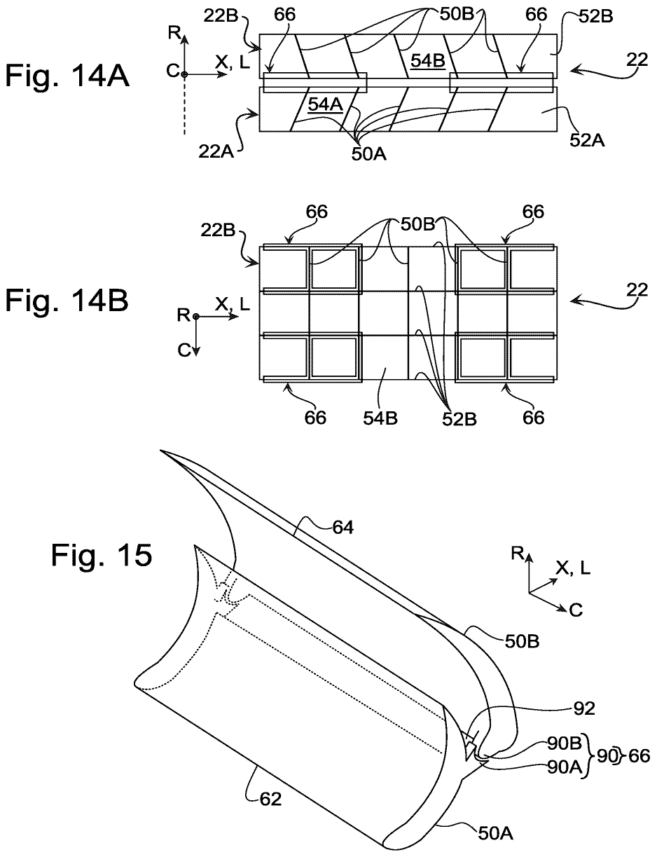

FIGS. 14A and 14B schematically summarize this principle, showing, on a particular example, regions where the connecting means 66 are located along segments of some rows of vanes 50A, 50B and along segments of the spars 52A, 52B.

FIG. 15 illustrates yet another example, wherein the rows of vanes 50A (of which only one is shown, in an isolated manner) are slightly axially offset from the rows of vanes 50B (of which one is also seen) and have a radial overlap relative to the latter, as in the example of FIG. 10. Furthermore, the connecting means 66 comprise mutual vane engagement means 90 provided in the form of cylindrical hinge supports. For a given pair of vanes 50A and 50B such as that seen in FIG. 15, such supports are for example defined together by support elements 90A, 90B respectively formed on the vanes 50A and 50B, and define passages 92 between them allowing circulation of the air flow between the vanes. When the spacing between consecutive spars is relatively substantial, such supports can advantageously be arranged at a distance from the spars to help stiffen the cascade.

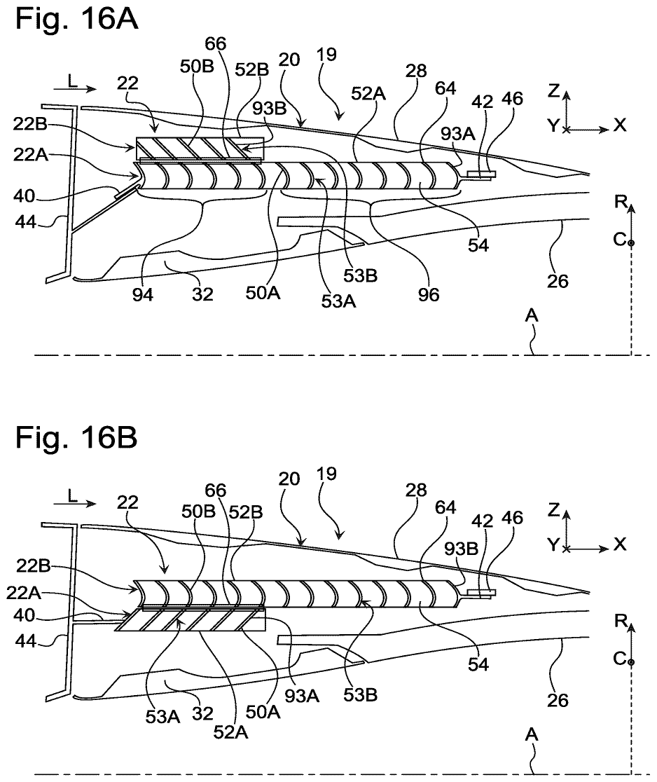

FIG. 16A illustrates a two-stage bladed cascade 22A, 22B according to an embodiment of the invention (similar overall to that of FIG. 6), within a thrust reverser 19 also similar to that of FIG. 3.

In this particular example, the cellular structure 53B of the outer stage 22B has a smaller axial extent than that of the cellular structure 53A of the inner stage 22A, which allows a rear end 93B of the cellular structure 53B of the outer stage 22B to be offset forward relative to a rear end 93A of the cellular structure 53A of the inner bladed stage 22A, preferably by a distance corresponding to several rows of vanes 50A of the inner stage 22A.

Thus, it is possible to make the best use of the space available for the cascade 22, given that said space is typically reduced toward the rear, given the aerodynamic profile of the cowl 20 and more generally of the rear section 18 of the nacelle.

For this purpose, the outer stage 22B thus comprises a lower number of rows of vanes 50B than that of the inner stage 22A. In the example illustrated, the rows of vanes 50B of the outer stage 22B are nonetheless arranged opposite consecutive rows of vanes 50A of the inner stage 22A, for example rows of vanes 50A forming a front end portion 94 of the inner stage 22A. A rear end portion 96 of this stage 22A is thus formed of other rows of vanes the trailing edge 64 of which directly faces the outer wall 26 of the cowl 20.

Furthermore, in the example illustrated, all or part of the connecting means 66, for example extensions such as the extensions 70A, 70B described above, are defined along segments corresponding substantially to the all of the spars 52B of the outer stage 22B. These connecting means 66 are shown very schematically in FIG. 16A, in the form of a rectangle as in FIGS. 14A, 14B.

It should also be noted that in this example, only the spars 52A of the inner stage 22A, but not the spars 52B of the outer stage 22B, are connected to the front 40 and rear 42 end flanges. The connecting means 66 therefore provide the whole connection between the outer stage 22B and the inner stage 22A. This example illustrates the flexibility provided by the invention in terms of cascade design. Indeed, as soon as the bladed stages 22A, 22B are connected to each other by their respective cellular structures 53A, 53B, it is not necessary for each of the bladed stages to be connected to the front 40 and rear 42 end flanges. A bladed stage, such as the outer stage 22B of FIG. 16A, can thus extend away from one—or both—of the flanges 40 and 42.

FIG. 16B illustrates a variant wherein the cellular structure 53B of the outer stage 22B has an axial extension greater than that of the cellular structure 53A of the inner stage 22A, such that a rear end 93B of the cellular structure 53B of the outer stage 22B is offset rearward relative to a rear end 93A of the cellular structure 53A of the inner stage 22A. Furthermore, in this example, one of the flanges, for example the front flange 40, is connected to the inner stage 22A, whereas the other flange, for example the rear flange 42, is connected to the outer stage 22B.

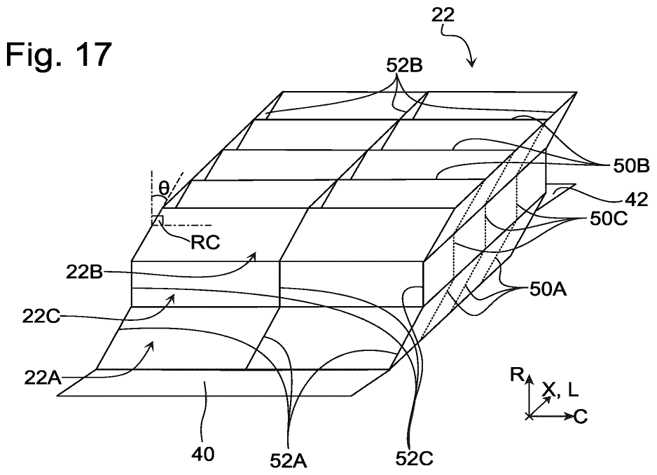

In other embodiments, the cascade 22 according to the invention can comprise a number of bladed stages greater than two, for example three bladed stages as shown schematically in FIG. 17.

Furthermore, the spars of one or more bladed stage(s) of the cascade can have an inclination in the circumferential direction C instead of being merely radially oriented as in the examples described above. The bladed stage(s) in question thus trigger a circumferential deflection of the air flow.

Thus, in the embodiment seen in FIG. 17, an inner stage 22A and an intermediate stage 22C have spars 52A, 52C oriented along the radial direction R, whereas an outer stage 22B of the cascade has spars 52B oriented along an angle θ defined relative to the radial direction R in a transverse plane RC.

As mentioned above, the connecting means 66 can be- or comprise-means for securing the respective cellular structures 53A, 53B of the bladed stages, so as to locally block any relative displacement between said structures. Such securing means can take the form of welds or adhesives, for example. In the examples described above, such securing means are in particular provided to attach, where applicable, the extensions 70A and 70B (in particular the tongues 78 and grooves 76), and the tongues 82 and grooves 84, together.

In the light of the examples described above, it should therefore be understood that the invention makes it possible to increase the performances of the thrust reverser cascades, while providing compatibility with inexpensive manufacturing processes, and by avoiding or at the very least limiting, thanks to the connection between cellular structures, problems of vibrational instability and aerodynamic disturbances encountered with two-stage cascades according to the prior art.

Furthermore, the invention allows optimized cascade configurations according to the space available, allowing, where applicable, superimposing of bladed stages of different lengths in the axial direction X. At the design stage of a nacelle, the options provided by the invention make it possible, for example, to increase the aerodynamic performances of a thrust reverser for a given nacelle length, or to reduce the length, and therefore the mass, of a nacelle, while maintaining consistent aerodynamic performances for the thrust reverser. The invention can particularly be put to good use by reducing the number of rows of vanes of a reverse cascade and compensating for this reduction by adding a bladed stage making it possible to increase the height of all or some of the remaining vanes of the cascade.

1. A cascade for a cascade thrust reverser for an aircraft propulsion assembly nacelle, comprising:
at least a first bladed stage and a second bladed stage which are superimposed, each comprising rows of vanes shaped to deflect an air flow, and spars which cross over with the vanes within each bladed stage so as to form together with the vanes a corresponding cellular structure for the passage of the air flow;
a front end flange and a rear end flange arranged respectively at a front end and a rear end of the cascade and each rigidly connected to all or some of the spars of at least one of the bladed stages;
wherein the respective cellular structures of the bladed stages are connected to each other, independently of the front and rear end flanges, by connecting means configured to block relative displacements between the cellular structures.

2. The cascade according to claim 1, wherein the connecting means comprise first extensions of spars of the first bladed stage and second extensions of spars of the second bladed stage, each of the first extensions being arranged facing a corresponding second extension so that the first and second extensions form mutual stops opposing relative displacements between the cellular structures.

3. The cascade according to claim 2, wherein the connecting means comprise mutual spar engagement means formed on the first extensions and the second extensions and cooperating mutually so as to block the relative displacements between the cellular structures.

4. The cascade according to claim 1, wherein the connecting means comprise mutual vane engagement means formed on vanes of the first bladed stage and on vanes of the second bladed stage and cooperating mutually so as to block relative displacements between the cellular structures.

5. The cascade according to claim 1, wherein the connecting means comprise means for securing the respective cellular structures of the bladed stages.

6. The cascade according to claim 1, wherein the first bladed stage is an inner bladed stage, and the second bladed stage is an outer bladed stage arranged on the inner bladed stage and of which at least one, among a front end and a rear end is offset from a corresponding front or rear end of the inner bladed stage, in a direction from the front flange to the rear flange.

7. The cascade according to claim 1, wherein the vanes of the second bladed stage extend in line with corresponding vanes of the first bladed stage.

8. The cascade according to claim 1, the vanes of the second bladed stage are offset relative to corresponding vanes of the first bladed stage, according to a direction from the front flange to the rear flange.

9. The cascade according to claim 1, wherein vanes of the first bladed stage comprise respective trailing edges extending beyond respective leading edges of vanes of the second bladed stage, in a direction from the first bladed stage to the second bladed stage.

10. A cascade thrust reverser for an aircraft propulsion assembly nacelle, comprising at least one cascade according to claim 1.
